(19) United States
(12) Patent Application Publication
(10) Pub. No.: US 2025/0353108 A1
(43) Pub. Date: Nov. 20, 2025

(54) LASER PROCESSING APPARATUS INCLUDING LASER SENSOR SYSTEM AND METHODS OF MEASUREMENT OF BEAM CHARACTERISTICS

(71) Applicant: ELECTRO SCIENTIFIC INDUSTRIES, INC., Beaverton, OR (US)

(72) Inventors: Jered RICHTER, Beaverton, OR (US); James BROOKHYSER, Beaverton, OR (US)

(73) Assignee: ELECTRO SCIENTIFIC INDUSTRIES, INC., Beaverton, OR (US)

(21) Appl. No.: 18/867,671

(22) PCT Filed: Apr. 18, 2023
(86) PCT No.: PCT/US2023/018938

§ 371 Date: Nov. 20, 2024

Related U.S. Application Data
(60) Provisional application No. 63/348,165, filed on Jun. 2, 2022.

(51) Int. Cl. B23K 26/082; B23K 26/06

(52) U.S. Cl. CPC B23K 26/082; B23K 26/0643

(57) ABSTRACT

An optical apparatus is disclosed. In one embodiment. the apparatus includes a photodetector apparatus having a photodetector, a first optical component arranged to direct a first beam path along which a beam of laser energy is propagatable to a first optical train configured to direct the first beam path to the photodetector, and a second optical component arranged to direct a second beam path along which the beam of laser energy is propagatable to a second optical train configured to direct the second beam path to the photodetector. The first optical train and the second optical train include a partially-transmissive mirror and a curved mirror configured to allow a first portion of the beam of laser energy to propagate therethrough, thereby imaging an AOD pivot point at a location relative to the detector apparatus. The photodetector may be positioned in a detection port of an integrating sphere.

### CROSS-REFERENCE TO RELATED APPLICATIONS

This application claims the benefit of U.S. Provisional Application No. 63/348,165, filed Jun. 2, 2022, the contents of which are incorporated by reference in their entirety.

### TECHNICAL FIELD

Embodiments described herein relate generally to laser-processing apparatuses and, more particularly, to laser sensor systems, the components thereof, and techniques for operating the same, in order to process a workpiece.

### BACKGROUND

Laser-processing systems or apparatus are used in a wide variety of applications, including printed circuit board (PCB) machining, additive manufacturing, and the like. To process PCBs, precise control of ablation of the PCB materials (e.g., metals, insulators, used in forming vias, etc.) is required when, for example, laser-processing is used to form holes or vias therein. Accurate and repeatable measurements of the power or energy of the processing laser beam is important for controlling ablation processes used to form these holes or vias. Laser sensor systems required for these precise measurements can be complex, expensive, and bulky. As such, there is a need for a laser sensor system that provides consistent and precise results with low system complexity and cost. The embodiments discussed herein were developed in recognition of these and other problems discovered by the inventors.

FIG. 1 illustrates a laser sensor system 30. The laser sensor system 30 include mirrors 32a, 32b, 34a, 34b, and photodetectors 36a and 36b, respectively. The mirrors 32a and 32b are provided to direct light propagating along beam paths 14a and 14b coming from the first positioner 106 to mirrors 34a and 34b. Mirrors 32a and 32b are provided as turn mirrors and the mirrors 34a and 34b are provided as partially-transmissive mirrors configured to reflect a majority of light in the incident beam of laser energy and transmit a small amount of the light to the detector 36a. The portions of the beam of laser energy not transmitted by the partially-transmissive mirrors 34a and 34b are directed to scan heads 120a and 120b, respectively. The detector 36a is arranged to receive light transmitted by partially-transmissive mirror 34a and the detector 36b is arranged to receive light transmitted by partially-transmissive mirror 34b. The detectors 36a and 36b are configured to sense or measure laser energy or power transmitted thereto, and generate sensor data based on the sensing or measurement.

### SUMMARY

One embodiment of the present invention can be characterized as an apparatus that includes: a detector apparatus comprising a photodetector; at least one first optical component arranged to direct a first beam path along which a beam of laser energy is propagatable to a first optical train configured to direct the first beam path to the detector apparatus; and at least one second optical component arranged to direct a second beam path along which the beam of laser energy is propagatable to a second optical train configured to direct the second beam path to the detector apparatus. The first optical train and the second optical train are configured to image an AOD pivot point at a location relative to the detector apparatus. The apparatus further comprises at least one laser source operative to generate the beam of laser energy.

The first optical train and the second optical train may include a partially-transmissive mirror and a curved mirror, wherein the partially-transmissive mirror is arranged and configured to receive the beam of laser energy, allow a first portion of the beam of laser energy to propagate therethrough, and reflect a second portion of the beam of laser energy. The curved mirror is arranged to receive the first portion beam of laser energy from the partially-transmissive mirror and reflect the first portion of the beam of laser energy to the detector apparatus. In one embodiment, the detector apparatus is an integrating sphere. The apparatus may further comprise a switch configured to selectively propagate the beam of laser energy to the first beam path or the second beam path. The switch may be an AOD system or a galvanometer system. The photodetector apparatus may comprise an integrating sphere having an integrating sphere body with a collection port and a detection port formed therein, wherein the photodetector is positioned in the detection port.

Another embodiment of the present invention can be characterized as an apparatus that includes: a detector apparatus comprising a photodetector; a first laser source operative to generate a first beam of laser energy; a second laser source operative to generate a second beam of laser energy; at least one first optical component arranged to direct a first beam path along which the first beam of laser energy or the second beam of laser energy is propagatable to a first optical train configured to direct the first beam path to the detector apparatus; and at least one second optical component arranged to direct a second beam path along which a first beam of laser energy or a second beam of laser energy is propagatable to a second optical train configured to direct the second beam path to the detector apparatus. The first optical train and the second optical train are configured to image an AOD pivot point at a location relative to the detector apparatus. The first optical train and the second optical train may include a partially-transmissive mirror and a curved mirror, wherein the partially-transmissive mirror is arranged and configured to receive the first beam of laser energy or the second beam of laser energy; allow a first portion of the first beam of laser energy or a first portion of the second beam of laser energy to propagate therethrough, and reflect a second portion of the first beam of laser energy or a second portion of the second beam of laser energy. The curved mirror is arranged to receive the first portion of the first beam of laser energy or the first portion of the second beam of laser energy from the partially-transmissive mirror and reflect the first portion of the first beam of laser energy or the first portion of the second beam of laser energy to the detector apparatus. The apparatus may further comprise a switch configured to selectively propagate the first beam of laser energy or the second beam of laser energy to the first beam path or the second beam path. The switch may be an AOD system or a galvanometer system. The photodetector apparatus may comprise an integrating sphere having an integrating sphere body with a collection port and a detection port formed therein, wherein the photodetector is positioned in the detection port.

### BRIEF DESCRIPTION OF THE DRAWINGS

FIG. 1 schematically illustrates a laser sensor system for a laser processing apparatus.

FIG. 2 schematically illustrates a laser-processing apparatus, according to one embodiment.

FIG. 3 schematically illustrates a laser sensor system, according to one embodiment.

FIG. 4 schematically illustrates a multi-source laser-processing apparatus, according to one embodiment.

FIG. 5 schematically illustrates a multi-source laser-processing apparatus, according to another embodiment.

FIG. 6 schematically illustrates the locations of beam paths entering an integrating sphere, according to one embodiment.

FIG. 7 schematically illustrates the locations of beam paths entering an integrating sphere, according to another embodiment.

### DETAILED DESCRIPTION

Example embodiments are described herein with reference to the accompanying drawings. Unless otherwise expressly stated, in the drawings the sizes, positions, etc., of components, features, elements, etc., as well as any distances therebetween, are not necessarily to scale, but are exaggerated for clarity. In the drawings, like numbers refer to like elements throughout. Thus, the same or similar numbers may be described with reference to other drawings even if they are neither mentioned nor described in the corresponding drawing. Also, even elements that are not denoted by reference numbers may be described with reference to other drawings.

The terminology used herein is for the purpose of describing particular example embodiments only and is not intended to be limiting. Unless otherwise defined, all terms (including technical and scientific terms) used herein have the same meaning as commonly understood by one of ordinary skill in the art. As used herein, the singular forms “a,” “an” and “the” are intended to include the plural forms as well, unless the context clearly indicates otherwise. It should be recognized that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Unless otherwise specified, a range of values, when recited, includes both the upper and lower limits of the range, as well as any sub-ranges therebetween. Unless indicated otherwise, terms such as “first,” “second,” etc., are only used to distinguish one element from another. For example, one node could be termed a “first node” and similarly, another node could be termed a “second node”, or vice versa.

Unless indicated otherwise, the term “about,” “thereabout,” etc., means that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art. Spatially relative terms, such as “below,” “beneath,” “lower,” “above,” and “upper,” and the like, may be used herein for ease of description to describe one element or feature's relationship to another element or feature, as illustrated in the FIGS. It should be recognized that the spatially relative terms are intended to encompass different orientations in addition to the orientation depicted in the FIGS. For example, if an object in the FIGS. is turned over, elements described as “below”, or “beneath” other elements or features would then be oriented “above” the other elements or features. Thus, the exemplary term “below” can encompass both an orientation of above and below. An object may be otherwise oriented (e.g., rotated 90 degrees or at other orientations) and the spatially relative descriptors used herein may be interpreted accordingly.

The section headings used herein are for organizational purposes only and, unless explicitly stated otherwise, are not to be construed as limiting the subject matter described. It will be appreciated that many different forms, embodiments and combinations are possible without deviating from the spirit and teachings of this disclosure and so this disclosure should not be construed as limited to the example embodiments set forth herein. Rather, these examples and embodiments are provided so that this disclosure will be thorough and complete, and will convey the scope of the disclosure to those skilled in the art.

### I. System Overview

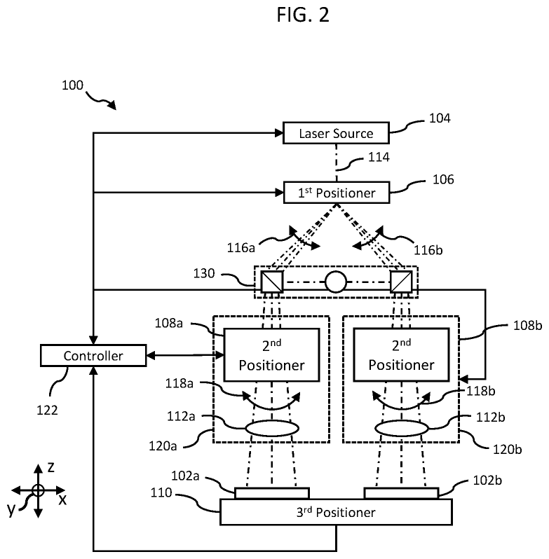

FIG. 2 schematically illustrates a laser-processing apparatus in accordance with one embodiment of the present invention.

Referring to the embodiment shown in FIG. 2, a laser-processing apparatus 100 (also referred to herein simply as an “apparatus”) for processing workpieces 102a and 102b (each generically referred to as a “workpiece 102”) can be characterized as including a laser source 104 for generating a beam of laser energy, a first positioner 106, a plurality of second positioners (e.g., second positioners 108a and 108b, each generically referred to as a “second positioner 108”), a third positioner 110 and a plurality of scan lenses (e.g., scan lens 112a and 112b, each generically referred to as a “scan lens 112”). Although FIG. 2 illustrates an embodiment in which the laser-processing apparatus 100 includes two second positioners 108, it will be appreciated that numerous embodiments disclosed herein can be applied to a laser-processing apparatus that includes more than two second positioners 108. The laser-processing apparatus 100 also includes a laser sensor system, such as laser sensor system 130, configured to measure properties of the beam of laser energy (e.g., power, energy, beam diameter, and the like), and provide measurement data representative of these properties to the controller 122.

A scan lens 112 and a corresponding second positioner 108 can, optionally, be integrated into a common housing or “scan head.” For example, scan lens 112a and a corresponding second positioner 108 (i.e., second positioner 108a) can be integrated into a common scan head 120a. Likewise, scan lens 112b and a corresponding second positioner 108 (i.e., second positioner 108b) can be integrated into a common scan head 120b. As used herein, each of scan head 120a and scan head 120b is also generically referred to herein as a “scan head 120.”

Although FIG. 2 illustrates a single third positioner 110 commonly supporting a plurality of workpieces 102, it will be appreciated that a plurality of third positioners 110 can be provided (e.g., to each support a different workpiece 102, to support a common workpiece 102, or the like or any combination thereof). In view of the description that follows, however, it should be recognized that inclusion of any second positioner 108 or the third positioner 110 is optional if the function provided by any second positioner 108 or third positioner 110 is not required.

As discussed in greater detail below, the first positioner 106 is operative to diffract, reflect, refract, or otherwise deflect the beam of laser energy so as to deflect a beam path 114 to any of the second positioners 108. As used herein, the term “beam path” refers to the path along which laser energy in the beam of laser energy travels as it propagates from the laser source 104 to a scan lens 112. When deflecting the beam path 114 to the second positioner 108a, the beam path 114 can be deflected by any angle (e.g., as measured relative to the beam path 114 incident upon the first positioner 106) within a first range of angles (also referred to herein as a “first primary angular range 116a”). Likewise, when deflecting the beam path 114 to the second positioner 108b, the beam path 114 can be deflected by any angle (e.g., as measured relative to the beam path 114 incident upon the first positioner 106) within a second range of angles (also referred to herein as a “second primary angular range 116b”). As used herein, each of the first primary angular range 116a and the second primary angular range 116b can also be generically referred to herein as a “primary angular range 116.” Generally, the first primary angular range 116a does not overlap with, and is not contiguous with, the second primary angular range 116b. The first primary angular range 116a may be larger than, smaller than or equal to the second primary angular range 116b. As used herein, the act of deflecting the beam path 114 within one or more of the primary angular ranges 116 is referred to herein as “beam branching.”

Each second positioner 108 is operative to diffract, reflect, refract, or the like, or any combination thereof, the beam of laser energy generated by the laser source 104 and deflected by the first positioner 106 (i.e., to “deflect” the beam of laser energy) so as to deflect the beam path 114 to a corresponding scan lens 112. For example, the second positioner 108a can deflect the beam path 114 to scan lens 112a. Likewise, the second positioner 108b can deflect the beam path 114 to scan lens 112b. When deflecting the beam path 114 to the scan lens 112a, the second positioner 108a can deflect the beam path 114 by any angle (e.g., as measured relative to the optical axis of the scan lens 112a) within a first range of angles (also referred to herein as a “first secondary angular range 118a”). Likewise, when deflecting the beam path 114 to the scan lens 112b, the second positioner 108b can deflect the beam path 114 by any angle (e.g., as measured relative to the optical axis of the scan lens 112b) within a second range of angles (also referred to herein as a “second secondary angular range 118b”). The first secondary angular range 118a may be larger than, smaller than or equal to the second secondary angular range 118b.

Laser energy deflected to a scan lens 112 is typically focused by the scan lens 112 and transmitted to propagate along a beam axis so as to be delivered to a workpiece 102. For example, laser energy deflected to scan lens 112a is delivered to workpiece 102a and laser energy transmitted deflected to scan lens 112b is delivered to workpiece 102b. Laser energy delivered to a workpiece 102 may be characterized as having a Gaussian-type spatial intensity profile or a non-Gaussian-type (i.e., “shaped”) spatial intensity profile (e.g., a “top-hat” spatial intensity profile, a super-Gaussian spatial intensity profile, etc.).

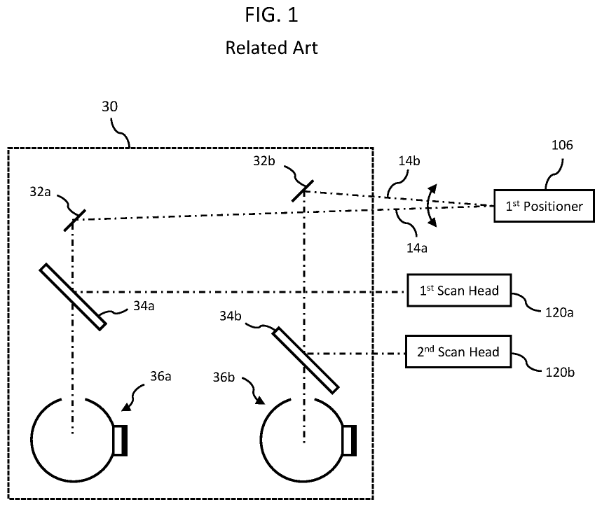

Although FIG. 1 illustrates a plurality of workpieces 102, each of which arranged so as to be intersected by a different beam axis, it will be appreciated that a single, larger workpiece 102 can be processed by laser energy that has been delivered from multiple scan lenses. Further, although FIG. 1 illustrates a plurality of scan lenses 112, each of which is arranged so as to transmit laser energy propagating along a beam path that has been deflected by a different second positioner 108, it will be appreciated that the apparatus 100 can be configured (e.g., with a mirror, prism, beam splitter, or the like or any combination thereof) such that laser energy propagating along beam paths deflected by multiple second positioners 108 are transmitted by a common scan lens 112.

### A. Laser Source

In one embodiment, the laser source 104 is operative to generate laser pulses. As such, the laser source 104 may include a pulse laser source, a CW laser source, a QCW laser source, a burst mode laser, or the like or any combination thereof. In the event that the laser source 104 includes a QCW or CW laser source, the laser source 104 may be operated in a pulsed mode, or may be operated in a non-pulsed mode but further include a pulse gating unit (e.g., an acousto-optic (AO) modulator (AOM), a beam chopper, etc.) to temporally modulate beam of laser radiation output from the QCW or CW laser source. The laser source 104 may be operated a “burst-mode” where multiple individual pulses may be grouped within a burst envelope. Within the burst envelope, power of each pulse and the time between each pulse may be tailored to specific laser-processing requirements. Thus, the laser source 104 can be broadly characterized as operative to generate a beam of laser energy, which may be manifested as a series of laser pulses or as a continuous or quasi-continuous laser beam, which can thereafter be propagated along the beam path 114. Although some embodiments discussed herein refer to laser pulses, it should be recognized that continuous or quasi-continuous beams may alternatively, or additionally, be employed whenever appropriate or desired.

In addition to wavelength, average power and, when the beam of laser energy is manifested as a series of laser pulses, pulse duration and pulse repetition rate, the beam of laser energy delivered to the workpiece 102 can be characterized by one or more other characteristics such as pulse energy, peak power, etc., which can be selected (e.g., optionally based on one or more other characteristics such as beam size, beam profile, polarization, beam parameter product (M²) spot size, pulse duration, average power and pulse repetition rate, etc.) to irradiate the workpiece 102 at the process spot at an optical intensity (measured in W/cm²), fluence (measured in J/cm²), etc., sufficient to process the workpiece 102 (e.g., to form one or more features).

### B. First Positioner

The first positioner 106 is arranged, located or otherwise disposed in the beam path 114 and is operated to diffract, reflect, refract, or the like, or any combination thereof, laser pulses that are generated by the laser source 104 so as to deflect or impart movement of the beam path 114 (e.g., relative to the scan lens 112) and, consequently, deflect or impart movement of the beam path 114 relative to the workpiece 102. For example, in one embodiment, the first positioner 106 is provided as an AO deflector (AOD) system, operative to deflect the beam path 114 by diffracting an incident laser beam. Generally, the first positioner 106 is operative to impart movement of the beam axis relative to the workpiece 102 along the X-axis (or direction), the Y-axis (or direction), or a combination thereof (e.g., by deflecting of the beam path 114 within the first primary angular range 116a, within the second primary angular range 116b, or a combination thereof). Although not illustrated, the Y-axis (or Y-direction) will be understood to refer to an axis (or direction) that is orthogonal to the illustrated X- and Z-axes (or directions).

In one embodiment, the operation of the first positioner 106 can be controlled to deflect the beam path 114 to the second positioner 108a (e.g., during a first branch period) and then to deflect the beam path 114 to the second positioner 108b (e.g., during a second branch period following the first branch period), or vice-versa or any combination thereof. In another example, the operation of the first positioner 106 can be controlled to simultaneously deflect the beam path 114 to the second positioner 108a and the second positioner 108b.

### C. Second Positioner

The second positioner 108 is disposed in the beam path 114 and is operated to diffract, reflect, refract, or the like or any combination thereof, laser pulses that are generated by the laser source 104 and passed by the first positioner 106 (i.e., to “diffract” the laser pulses) so as to deflect or impart movement to the beam path 114 (e.g., relative to the scan lens 112) and, consequently, deflect or impart movement of the beam path 114 relative to the workpiece 102. Generally, the second positioner 108 is operative to impart movement of the beam axis relative to the workpiece 102 along the X-axis (or direction), the Y-axis (or direction), or a combination thereof (e.g., by deflecting the beam path 114 within the first secondary angular range 118a or within the second secondary angular range 118b).

In view of the above, it should be appreciated that the second positioner 108 can be provided as an AOD system, a galvanometer mirror scanning system, a rotating polygon mirror system, a deformable mirror, a micro electro-mechanical system (MEMS) reflector, or the like or any combination thereof.

### D. Third Positioner

The third positioner 110 is operative to impart movement of a workpiece 102 (e.g., workpieces 102a and 102b) relative to the scan heads 120a and 120b, and, consequently, impart movement of the workpiece 102 relative to the beam path 114.

In the illustrated embodiment, the third positioner 110 includes one or more linear stages (e.g., each capable of imparting translational movement to the workpiece 102 along the X-, Y- and/or Z-directions), one or more rotational stages (e.g., each capable of imparting rotational movement to the workpiece 102 about an axis parallel to the X-, Y- and/or Z-directions), or the like or any combination thereof arranged and configured to impart relative movement between a workpiece 102 and the scan lens 112, and, consequently, to impart relative movement between the workpiece 102 and the beam path 114. In the illustrated embodiment, the third positioner 110 is operatable to move the workpiece 102. In another embodiment, however, the third positioner 110 is arranged and operative to move the scan head and, optionally, one or more components such as the first positioner 106, and the workpiece 102 may be kept stationary.

### E. Scan Lens

The scan lens 112 (e.g., provided as either a simple lens, or a compound lens) is generally configured to focus the beam of laser energy directed along the beam path, typically so as to produce a beam waist that can be positioned at or near the desired process spot.

### F. Controller

Generally, the apparatus 100 includes one or more controllers, such as controller 122, to control, or facilitate control of, the operation of the apparatus 100. In one embodiment, the controller 122 is communicatively coupled (e.g., over one or more wired or wireless communications links, fiber-optic links, and the like or any combination thereof) to one or more components of the apparatus 100, such as the laser source 104, the first positioner 106, the second positioner 108, third positioner 110, etc., which are thus operative in response to one or more control signals output by the controller 122.

### G. Embodiments Concerning Laser Sensor Systems

### i. Embodiments of Laser Sensor Systems Using a Single Laser and a Single Detector

In some embodiments, the apparatus 100 may be provided with a laser sensor system having a common detector operative to measure the optical power directed to multiple workpieces, thereby reducing system complexity and cost, compared to systems that have multiple detectors. For example, in processing systems with multiple scan heads, during separate branch periods (e.g., by beam branching or pulse slicing as described above), the beam of laser energy may be measured by the common detector using the first positioner to direct the beam path to separate optical trains. The separate optical trains then direct a fraction of the beam (e.g., by partially-transmissive mirrors) to the common detector to measure optical power, while the majority of the beam power is directed to the respective scan heads.

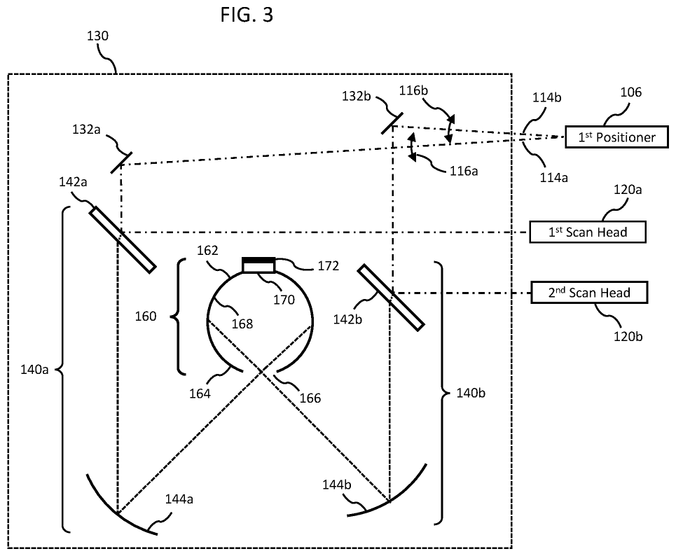

Referring to FIG. 3, a laser sensor system, such as laser system 130, includes optical components 132a, 132b, optical trains 140a and 140b and a detector apparatus 160. In this embodiment, the first optical train 140a includes a first mirror 142a and a first curved mirror 144a, and the second optical train 140b includes a second mirror 142b and a second curved mirror 144b. The detector apparatus 160 includes an integrating sphere 162 with an integrating sphere body 164 having a collection port 166, an interior surface 168, a detection port 170, and a photodetector 172 mounted in a detection port 170.

The optical components 132a and 132b are operative to direct light propagating along beam paths 114a and 114b deflected by the first positioner 106 through the first primary angular range 116a and the second primary angular range 116b (e.g., during a first branch period and a second branch period, respectively) to the first optical train 140a and the second optical train 140b, respectively. Determination of the branch period during which the beam is measured can be determined by establishing a relationship between the time that the control commands are sent by the controller 122 to the first positioner 106, and, the time that the laser measurement data is received by the controller from the common detector. As such, the controller 122 may be configured to determine which beam path (e.g., beam path 114a or beam path 114b shown in FIG. 3) is being directed to the laser sensor system 130 by comparing the timing of the particular branch period (e.g., the first branch period or a second branch period as described above) to the measurement data received by the controller 122.

The optical components 132a and 132b can, for example, be provided as knife-edge mirrors (e.g., wherein the specified surface characteristics such as flatness, roughness, and scratch/dig resistance extend all the way to at least one edge of the mirror) and the mirrors 142a and 142b can, for example, be provided as partially-transmissive mirrors configured to reflect a majority of light in the incident beam of laser energy and transmit a small amount of the light (e.g., 2% or thereabout), to the mirrors 144a and 144b arranged to receive the light transmitted by a corresponding partially-transmissive mirror and reflect that light to the detector apparatus 160. The light not transmitted by the partially-transmissive mirrors 142a and 142b is directed to scan heads 120a and 120b, respectively. In some embodiments, imaging optics (e.g., focusing or collimating optics operative to change the beam diameter and control laser fluence) may also be introduced into the optical trains 140a, 140b or elsewhere in the laser sensor system 130. In other embodiments, the optical components 132a and 132b may be provided as turn mirrors.

In the embodiment shown, the detector apparatus 160 includes a photodetector 172 configured to sense or measure laser energy or power transmitted thereto, and generate sensor data representative of the sensing or measurement. In other embodiments, the detector apparatus 160 may include a laser beam profiler (not shown) configured to measure any number of beam characteristics including without limitation, beam diameter, M² beam propagation factor, and the like, and generate sensor data representative of the beam profile measurements. The sensor data can be output to the controller 122 by any suitable means, where it can be thereafter processed to support various functions of the apparatus 100, such as real-time pulse energy control (e.g., to compensate for changes in laser power), system calibrations (e.g., to compensate for transmission changes in the AOD systems of the first positioner 106 vs. RF power and frequency, etc.), or the like or any combination thereof.

Because the detector apparatus 160 is located optically downstream of the first positioner 106, readings taken by the photodetector 172 can vary depending upon the position or angle of the beam of energy incident thereto. Thus, movement of an incident beam of laser energy over the photodetector 172 can cause a reading error, which can result in erroneous power control, system calibrations, etc. To reduce or eliminate the spatial and directional sensitivity associated with the photodetector, each of the laser sensor systems may include a beam expander and/or diffuser (not shown) arranged so as to expand and/or diffuse the beam of laser energy before the beam of laser energy strikes the photodetector 172. As such, in the embodiment shown in FIG. 3, the laser sensor system 130 may be provided with the integrating sphere 162 arranged optically upstream of the photodetector 172 to reduce the spatial and directional sensitivity associated with the photodetector 172. The integrating sphere 162 may be provided as an alternative to, or to supplement, the aforementioned use of the beam expander/diffuser. Generally, and as is known in the art, the integrating sphere 162 is an optical component that includes a hollow spherical (or at least substantially spherical) body with a cavity, the interior surface of which is coated with a diffusive reflective coating. The integrating sphere 162 is arranged such that light propagating from the partially-transmissive mirror (i.e., from mirror 142a or 142b) can enter into the cavity of the integrating sphere 162 through the collection port 166 and be incident on the interior surface 168. At least a portion of the light incident on any point on the interior surface 168 of the cavity is scattered and, ultimately, exits the integrating sphere 162 at the detection port 170 so as to be incident upon the photodetector 172. Light not transmitted to the detector apparatus 160 by the partially-transmissive mirrors 142a and 142b is directed to scan heads 120a and 120b, respectively.

In some embodiments, the first positioner 106 may function as a switch operative to select the beam path (i.e., first beam path 114a and/or second beam path 114b) along which the laser energy propagates.

### ii. Embodiments of Laser Sensor Systems Using a Single Detector with Multiple Laser Sources

Some embodiments of the present invention provide an apparatus having multiple laser sources (also referred to herein as a “multi-source apparatus”). Each of the laser sources may direct laser energy to one of multiple workpieces, or both of the laser sources may direct laser energy to a single workpiece. The use of two laser sources can provide the laser processing apparatus with additional processing flexibility and/or higher throughput. The laser sources may be provided to operate at substantially the same wavelength(s), and substantially the same spectral bandwidth. For example, in one embodiment, the first laser source and the second laser source are operative to generate a beam of laser energy having one or more wavelengths in the visible (e.g., green) range of the electromagnetic spectrum. In another embodiment, at least one of the wavelengths and spectral bandwidths of laser energy generated by the first laser source may be different from (e.g., greater than, less than, or any combination thereof) the laser energy generated by the second laser source.

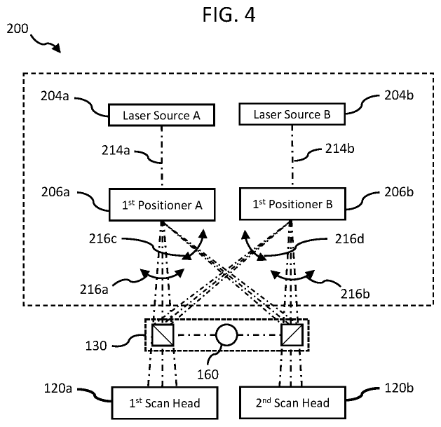

FIG. 4 schematically illustrates an embodiment of a multi-source apparatus, such as apparatus 200, that is configured with multiple laser sources and the laser sensor system 130 as described above with respect to FIG. 3. As shown in FIG. 4, the apparatus 200 includes a first laser source 204a and a second laser source 204b. Generally, the first laser source 204a and the second laser source 204b are both operative to generate laser energy sufficient to process the workpieces 102a and 102b shown in FIG. 1. Each of the first laser source 204a and the second laser source 204b may be provided as exemplarily described above with respect to the laser source 104. The laser energy from the first laser source 204a propagates along a first beam path 214a to a first primary positioner 206a, and the laser energy from the second laser source 204b propagates along a second beam path 214b to a second primary positioner 206b. The first primary positioner 206a is operative to diffract, reflect, refract, or otherwise deflect the beam of laser energy so as to deflect the beam path 214a to either the first scan head 120a or the second scan head 120b. Likewise, the second primary positioner 206b is also operative to diffract, reflect, refract, or otherwise deflect the beam of laser energy so as to deflect the beam path 214b to either the first scan head 120a or the second scan head 120b. The first primary positioner 206a and the second primary positioner 206b are each provided as AOD system (such as the first positioner 106 described above), but may be provided as any other desired or suitable type of positioner (e.g., a galvanometer mirror scanning system, a rotating polygon mirror system, a deformable mirror, a micro electro-mechanical system (MEMS) reflector, or the like or any combination thereof).

When deflecting the beam path 214a to the first scan head 120a, the beam path 214a can be deflected by any angle (e.g., as measured relative to the beam path 214a incident upon the first primary positioner 206a) within a first range of angles (also referred to herein as a “first primary angular range 216a”) by the first primary positioner 206a. In addition, the first primary positioner 206a may deflect the beam path 214a to the second scan head 120b (e.g., as measured relative to the beam path 214a incident upon the second primary positioner 206b) within an alternate first range of angles (also referred to herein as a “alternate first primary angular range 216c”).

Likewise, when deflecting the beam path 214b to the second scan head 120b, the beam path 214b can be deflected by any angle (e.g., as measured relative to the beam path 214b incident upon the second primary positioner 206b) within a second range of angles (also referred to herein as a “second primary angular range 216b”) by the second primary positioner 206b. In addition, the second primary positioner 206b may deflect the beam path 214b to the first scan head 120a (e.g., as measured relative to the beam path 214b incident upon the second primary positioner 206b) within an alternate second range of angles (also referred to herein as a “alternate second primary angular range 216d”).

In this embodiment, the laser sensor system 130 (as described above with respect to FIG. 3), is positioned optically downstream of the first primary positioner 206a and the second primary positioner 206b so that either of beam paths 214a and 214b can be directed to the detector apparatus 160 (e.g., when the beam paths 214a and 214b are deflected though the angular ranges 216a, 216b, 216c, or 216d, during, for example, first, second, third or fourth branch periods or slice periods, respectively), before the beam paths 214a and 214b reach the first scan head 120a and the second scan head 120b.

The laser sensor system 130 is provided in substantially the same manner as described above with respect to FIG. 3. The beam paths 214a and 214b can be directed to the first optical train 140a or the second optical train 140b by the mirrors 132a and 132b, respectively. The portions of the light transmitted by the partially-transmissive mirrors 142a and 142b are directed by the curved mirrors 144a and 144b, respectively to the detector apparatus 160 where they enter the collection port 166 of the integrating sphere 162 and exit the detection port 170 to be detected by the photodetector 172. The portions of the light not transmitted by the partially-transmissive mirrors 142a and 142b are directed to scan heads 120a and 120b, respectively.

Determination of the branch period during which the beam is measured can be determined by establishing a relationship between the time that the control commands are sent by the controller 122 to the first primary positioner 206a or the second primary positioner 206b, and the time that the laser measurement data is received by the controller from the detector apparatus 160. As such, the controller 122 may be configured to determine which beam path (e.g., 214a or 214b shown in FIG. 4) is being measured by the laser sensor system 130 by comparing the timing of the particular branch period (e.g., the first branch period or a second branch period as described above) and the measurement data received by the controller 122.

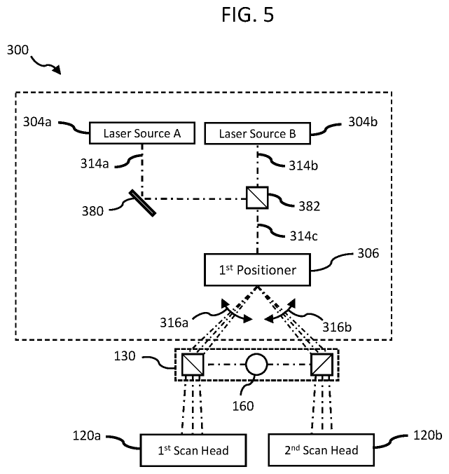

FIG. 5 schematically illustrates an embodiment of a multi-source apparatus, such as apparatus 300, that is configured with multiple laser sources and the laser sensor system 130 as described above with respect to FIG. 3. As shown in FIG. 5, the apparatus 300 includes a first laser source 304a and a second laser source 304b. Generally, the first laser source 304a and the second laser source 304b are both operative to generate laser energy sufficient to process the workpieces 102a and 102b shown in FIG. 1. Each of the first laser source 304a and the second laser source 304b may be provided as exemplarily described above with respect to the laser sources 204a and 204b. In other embodiments, more than two laser sources may be provided.

In this embodiment, the laser energy from the first laser source 304a propagates along a first beam path 314a and the laser energy from the second laser source 304b propagates along a second beam path 314b. Laser energy propagating along the first beam path 314a and the second beam path 314b may be spatially combined in any suitable manner. For example, a fold mirror 380 may be provided to direct the first beam path 314a into a beam combiner 382, which is also disposed in the second beam path 314b. Upon exiting the beam combiner 382, laser energy can propagate along a common beam path 314c (e.g., corresponding to the beam path 114 shown in FIG. 1) to a first positioner 306. The first positioner 306 is operative to diffract, reflect, refract, or otherwise deflect the beam of laser energy so as to deflect the common beam path 314c by any angle (e.g., as measured relative to the common beam path 314c incident upon the first positioner 306) through a first primary angular range 316a (e.g., during a first branch period or slice period) to the first scan head 120a through the laser sensor system 130 and through a second primary angular range 316b (e.g., during a second branch period or slice period) to the second scan head 120b through the laser sensor system 130. Determination of the branch period during which the beam is measured can be determined by establishing a relationship between the time that the control commands are sent by the controller 122 to the first positioner 306, and the time that the laser measurement data is received by the controller from the detector apparatus 160. As such, the controller 122 may be configured to determine which angular range (e.g., 316a or 316b shown in FIG. 5) is being measured by the laser sensor system 130 by comparing the timing of the particular branch period (e.g., the first branch period or a second branch period as described above) and the measurement data received by the controller 122.

The laser sensor system 130 is provided in substantially the same manner as described above with respect to FIG. 3. The beam path 314c can be directed through a first primary angular range 316a to the first optical train 140a and through a second primary angular range 316b to the second optical train 140b by the mirrors 132a and 132b, respectively. The portions of the light transmitted by the partially-transmissive mirrors 142a and 142b are directed by the curved mirrors 144a and 144b, respectively, to the detector apparatus 160 where they enter the collection port 166 of the integrating sphere 162 and exit the detection port 170 to be detected by the photodetector 172. The portions of the light not transmitted by the partially-transmissive mirrors 142a and 142b are directed to scan heads 120a and 120b, respectively.

### iii. Embodiments Concerning Control of the Location of a Pivot Point with Respect to Collection Port of an Integrating sphere

Generally, as described above, the use of an integrating sphere for optical power measurements can reduce the spatial and directional sensitivity associated with measurement by photodetectors. Nevertheless, in some embodiments where integrating spheres are used, the sensor data representative of a measured characteristic of the beam entering an integrating sphere may vary as a function of the location where the beam path enters the collection port of integrating sphere, or as a function of the location on the interior surface of the integrating sphere the beam is incident on. In addition, the sensor data representative of the measured characteristic of a beam entering an integrating sphere (and the scattered light exiting the detection port) may vary as a function of the angle of the beam path as it enters the collection port of the integrating sphere (e.g., through the ranges of angles that the beam paths 114a, 114b, 214a, 214b and 314c are deflected by their respective positioners 106, 206a, 206b, or 306). To control or reduce such variations, the beam paths may be directed to the detector apparatus 160 (e.g., by the optical trains 140a and 140b) so that the image of the AOD pivot point (when the positioners are provided as AODs) is located consistently with respect to the integrating sphere 162 (e.g., the collection port 166 or the interior surface 168). So, locating the AOD pivot point at a specific point (e.g., the center of the entrance port) ensures that the beam enters the sphere in a spatially consistent manner that can reduce detector signal sensitivity to scanning position or angle.

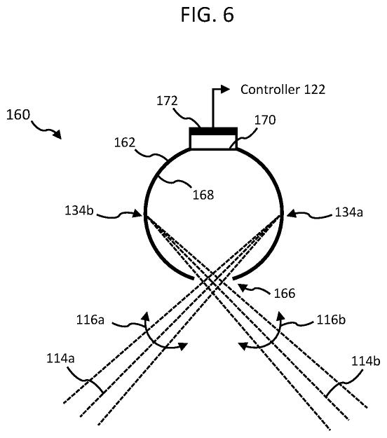

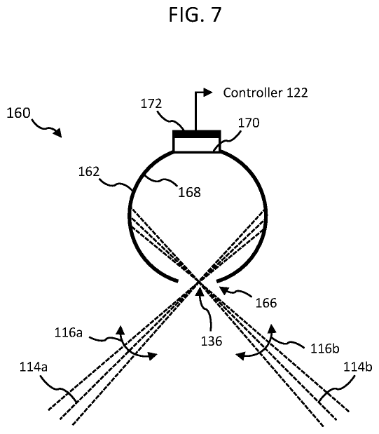

FIGS. 6 and 7 schematically illustrate embodiments of the detector apparatus 160 wherein a pivot point is located at different positions with respect to the collection port 166 or the interior surface 168 of the integrating sphere 162. In these embodiments, the detector apparatus 160 is provided as described above with respect to FIG. 3.

As shown in FIG. 6, as the first beam path 114a is deflected within the first primary angular range 116a, depending on the curvature of the curved mirror 144a of the first optical train 140a (shown in FIG. 3), or the presence of other optical elements in the first optical train 140a (or located optically upstream thereof), the curved mirror 144a directs the beam path 114a to the integrating sphere 162 and images the AOD pivot point at a pivot point 134a on the interior surface 168 of the integrating sphere 162. In similar fashion, as the second beam path 114b is deflected within the second primary angular range 116b, depending on the curvature of the curved mirror 144b of the second optical train 140b (shown in FIG. 3) or the presence of other optical elements in the second optical train 140b (or optically upstream thereof), the curved mirror 144b directs the beam path 114b to the integrating sphere 162 and images the AOD pivot point at a pivot point 134b on the interior surface 168 of the integrating sphere 162. In this instance, location of the pivot points 134a and 134b at or near the surface 168 of the integrating sphere 162 may reduce the positional sensitivity of the optical power sensed by the photodetector 172. When provided as such, the laser sensor system 130 and the detector apparatus 160 may be used to provide consistent measurements of the beam propagating along the beam paths 114a and 114b. Though not shown in FIG. 6, the same is true for the beam paths 214a and 214b, (e.g., as they are deflected within their respective angular ranges 216a, 216c, 216b, and 216d as shown in FIG. 4) and 314c (e.g., as it is deflected within the angular ranges 316a and 316b).

As shown in FIG. 7, as the first beam path 114a is deflected within the first angular range 116a, depending on the curvature of the curved mirror 144a of the first optical train 140a (shown in FIG. 3), or the presence of other optical elements in the first optical train 140a (or located optically upstream thereof), the curved mirror 144a directs the beam path 114a to the integrating sphere 162 and images the AOD pivot point at a pivot point 136 located at or near the center of the collection port 166 of the integrating sphere 162. Location of the pivot point 136 at or near the center of the collection port 166 may result the beam path being incident on the interior surface 168 of the integrating sphere 162 in a spatially consistent manner. In similar fashion, depending on the curvature of the curved mirror 144b (shown in FIG. 3) or the presence of other optical elements in the second optical train 140b (or located optically upstream thereof), the curved mirror 144b directs the beam path 114b to the integrating sphere 162 and images the AOD pivot point at the same pivot point 136 located at or near the center of the collection port 166 of the integrating sphere 162. As such, location of the pivot point 136 at or near the center of the collection port 166 may reduce the positional sensitivity of the optical power sensed by the photodetector 172. When provided as such, the laser sensor system 130 and the detector apparatus 160 may be used to provide consistent measurements of the beams propagating along the beam paths 114a and 114b. Though not shown in FIG. 7, the same is true for beam paths 214a and 214b, (e.g., as they are deflected within their respective angular ranges 216a, 216c, 216b, and 216d as shown in FIG. 4) and 314c (e.g., as it is deflected within the angular ranges 316a and 316b shown in FIG. 5).

### II. CONCLUSION

The foregoing is illustrative of embodiments and examples of the invention, and is not to be construed as limiting thereof. Although a few specific embodiments and examples have been described with reference to the drawings, those skilled in the art will readily appreciate that many modifications to the disclosed embodiments and examples, as well as other embodiments, are possible without materially departing from the novel teachings and advantages of the invention. Accordingly, all such modifications are intended to be included within the scope of the invention as defined in the claims. For example, skilled persons will appreciate that the subject matter of any sentence, paragraph, example or embodiment can be combined with subject matter of some or all of the other sentences, paragraphs, examples or embodiments, except where such combinations are mutually exclusive. The scope of the present invention should, therefore, be determined by the following claims, with equivalents of the claims to be included therein.

What is claimed is:

1. An apparatus, comprising:
a detector apparatus including a photodetector;
at least one first optical component arranged to direct a first beam path along which a beam of laser energy is propagatable to a first optical train configured to direct the first beam path to the detector apparatus; and
at least one second optical component arranged to direct a second beam path along which the beam of laser energy is propagatable to a second optical train configured to direct the second beam path to the detector apparatus.

2. The apparatus of claim 1, wherein the first optical train and the second optical train are configured to image an AOD pivot point at a location relative to the detector apparatus.

3. The apparatus of claim 1, further comprising at least one laser source operative to generate the beam of laser energy.

4. The apparatus of claim 1, wherein the first optical train and the second optical train include:
a partially-transmissive mirror; and
a curved mirror.

5. The apparatus of claim 4, wherein the partially-transmissive mirror is arranged to:
receive the beam of laser energy;
allow a first portion of the beam of laser energy to propagate therethrough and reflect a second portion of the beam of laser energy.

6. The apparatus of claim 5, wherein the curved mirror is arranged to receive the first portion of the beam of laser energy from the partially-transmissive mirror and reflect the first portion of the beam of laser energy to the detector apparatus.

7. The apparatus of claim 1, wherein the detector apparatus is an integrating sphere.

8. The apparatus of claim 1, further comprising a switch configured to selectively propagate the beam of laser energy to the first beam path or the second beam path.

9. The apparatus of claim 8, wherein the switch is an AOD system.

10. The apparatus of claim 8, wherein the switch is a galvanometer system.

11. The apparatus of claim 1, wherein the detector apparatus comprises:
an integrating sphere having an integrating sphere body with a collection port and a detection port formed therein,
wherein the photodetector is positioned in the detection port.

12. An apparatus, comprising:
a detector apparatus including a photodetector;
a first laser source operative to generate a first beam of laser energy;
a second laser source operative to generate a second beam of laser energy;
at least one first optical component arranged to direct a first beam path along which the first beam of laser energy or the second beam of laser energy is propagatable to a first optical train configured to direct the first beam path to the detector apparatus; and
at least one second optical component arranged to direct a second beam path along which the first beam of laser energy or the second beam of laser energy is propagatable to a second optical train configured to direct the second beam path to the detector apparatus.

13. The apparatus of claim 12, wherein the first optical train and the second optical train are configured to image an AOD pivot point at a location relative to the detector apparatus.

14. The apparatus of claim 12, wherein the first optical train and the second optical train include:
a partially-transmissive mirror; and
a curved mirror.

15. The apparatus of claim 14, wherein the partially-transmissive mirror is arranged to:
receive the first beam of laser energy or the second beam of laser energy;
allow a first portion of the first beam of laser energy or the second beam of laser energy to propagate therethrough; and
reflect a second portion of the first beam of laser energy or the second beam of laser energy.

16. The apparatus of claim 15, wherein the curved mirror is arranged to receive the first portion of the first beam of laser energy or the second beam of laser energy from the partially-transmissive mirror and reflect the first portion of the first beam of laser energy or the second beam of laser energy to the detector apparatus.

17. The apparatus of claim 12, further comprising a switch configured to selectively propagate the first beam of laser energy or the second beam of laser energy to the first beam path or the second beam path.

18. The apparatus of claim 17, wherein the switch is an AOD system.

19. The apparatus of claim 17, wherein the switch is a galvanometer system.

20. The apparatus of claim 12, wherein the detector apparatus comprises:
an integrating sphere having an integrating sphere body with a collection port and a detection port formed therein,
wherein the photodetector is positioned in the detection port.
